(19) United States
(12) Patent Application Publication
(10) Pub. No.: US 2025/0375752 A1
(43) Pub. Date: Dec. 11, 2025

(54) DATA STORAGE DEVICE INCLUDING AN ADSORBENT COMPOSITION, AND RELATED ARTICLES, SYSTEMS, AND METHODS

(71) Applicant: Seagate Technology LLC, Fremont, CA (US)

(72) Inventors: Michael Yi Zhao Yao, Singapore (SG); XingYong Zhang, Shenzhen City (CN); XiaoJin Wu, Wuxi City (CN); Lihong Zhang, Singapore (SG); Nathan Thamilmani Senthil, Singapore (SG); Brijesh Kumar Singh, Singapore (SG); Daniel R. Stevens, Longmont, CO (US)

(21) Appl. No.: 18/747,717

(22) Filed: Jun. 19, 2024

(30) Foreign Application Priority Data
Jun. 7, 2024 (CN) 202410741089.0

(51) Int. Cl. B01J 20/18; B01J 20/28; B01J 20/30; G11B 33/14

(52) U.S. Cl. CPC B01J 20/18; B01J 20/28026; B01J 20/2803; B01J 20/2805; B01J 20/2808; B01J 20/3042; B01J 20/3085; G11B 33/1453

(57) ABSTRACT

Data storage devices that includes one or more articles. An article includes an adsorbent composition having one or more molecular sieves for adsorbing one or more organic compounds, and a binder component that includes at least one cured rubber. Related methods of making an article.

### CROSS-REFERENCE TO RELATED APPLICATION

This nonprovisional patent application claims priority to Chinese Patent Application Serial Number 202410741089.0, filed on Jun. 7, 2024, wherein said Chinese patent application is incorporated herein by reference in its entirety.

### BACKGROUND

The present disclosure relates to adsorbent compositions for adsorbing moisture and/or organic compounds in data storage devices like hard disk drives (HDDs). There is a continuing need for improved adsorbent compositions for managing the relative humidity and/or organic contamination within data storage devices that use electrical power to store and retrieve data.

### SUMMARY

The present disclosure includes embodiments of an article adapted to be disposed in a housing of a sealed, data storage device. The article includes an adsorbent composition. The adsorbent composition includes a molecular sieve component and a binder component. The molecular sieve component includes one or more molecular sieves that can adsorb one or more organic compounds. The binder component includes at least one cured rubber.

The present disclosure also includes embodiments of a method of making an article adapted to be disposed in a housing of a sealed, data storage device. The method includes forming a mixture. The mixture includes a molecular sieve component and a binder component. The molecular sieve component includes one or more molecular sieves that can adsorb one or more organic compounds. The binder component includes at least one rubber. The method also includes forming the mixture into the article.

### BRIEF DESCRIPTION OF THE DRAWINGS

The discussion below makes reference to the following figures, wherein the same reference number may be used to identify the similar/same component in multiple figures. The schematic figures are for illustration purposes and are not necessarily drawn to scale.

FIG. 1A is an exploded, perspective view of an example of a hard disk drive that may include one or more adsorbent compositions according to the present disclosure;

FIG. 1B is a perspective view of the hard disk drive shown in FIG. 1A in its assembled configuration and showing interior components in broken lines;

FIG. 2 is an exploded view of an example of a recirculation filter that can include an adsorbent composition according to the present disclosure;

FIG. 3A is a perspective view of an environmental control module (ECM) that can include an adsorbent composition according to the present disclosure;

FIG. 3B is an exploded, perspective view of an environmental control module (ECM) shown in FIG. 3A;

FIG. 4A is an elevation view of a label filter that can include an adsorbent composition according to the present disclosure;

FIG. 4B is a cross-sectional view of the label filter shown in FIG. 4A;

FIG. 5 is a block diagram of a data center system including a plurality of data storge devices according to the present disclosure.

### DETAILED DESCRIPTION

Moisture and/or organic materials (solid particle aerosol debris and/or vapor) may be present in an interior volume of a data storage device such as hard disk drive (HDD) from a variety of sources such as components within the HDD, and may contribute to reduced performance (e.g., reduced areal density capability) and/or reduced lifetime of the HDD. Water vapor, organic aerosol particulates, and/or organic vapor, may compromise performance of an HDD by contaminating, degrading, and/or damaging components such as magnetic recording heads.

An HDD may include one or more components such as one or more filters or an environmental control module (ECM), among others, that include an adsorbent composition that is configured to mitigate such contamination. An adsorbent component may include solid particles that can be formed into an absorbent composition having a particular shape as a defined volume using a binder component that helps retain the shape. The binder component can also help cohere and retain the particles so that they do not become separated from the article to an undue degree. A binder component can include one or more organic binders. An organic binder includes one or more organic compounds, which may be present in an organic solvent, that are combined with an adsorbent component to form an adsorbent composition suitable for use in a component such as an ECM or filter. The organic binders and/or solvents can themselves can create significant organic contamination by outgassing after being placed in an HDD. An example of organic binder that can contribute to an undue amount of outgassing and that can be used with activated carbon is polytetrafluoroethylene (PTFE). PTFE can be present as dispersion solution with one or more solvents and/or more surfactants when combined with activated carbon to form an article having a shape for use in a recirculation filter.

An example of an adsorbent composition that can adsorb organic vapors includes activated carbon, which is used to make, e.g., recirculation filters for use in HDDs. In addition to adsorbing organic vapors, activated carbon can also adsorb oxygen, which can be undesirable. For example, a sealed, data storage devices such a heat-assisted magnetic recording (HAMR) hard disk drive can benefit from relatively low amounts of oxygen mixed with helium gas in an interior volume of the HDD. Unfortunately, recirculation filters that include activated carbon can adsorb and significantly reduce the oxygen content in an interior volume of a sealed, data storage device such as a HAMR HDD.

According to one aspect of the present disclosure, one or more molecular sieves that can adsorb one or more organic compounds are used to replace at least a portion of activated carbon in an adsorbent composition. In some embodiments, the adsorbent composition does not include any activate carbon. Advantageously, one or more molecular sieves can be selected that absorb one or more organic compounds while not adsorbing oxygen to an undue degree.

According to another aspect of the present disclosure, rubber is used to replace at least a portion of organic binders that outgas to undue degree. In some embodiments, the binder component does not include any organic binders that outgas to undue degree. Advantageously, one or more rubbers can be exposed to relatively high temperatures that can help reduce or decompose residual organic material that may be present in the adsorbent composition prior to completing the manufacture of a data storage device so that that organic material does not outgas to an undue degree into an interior volume of a sealed, data storage device such as a HAMR HDD.

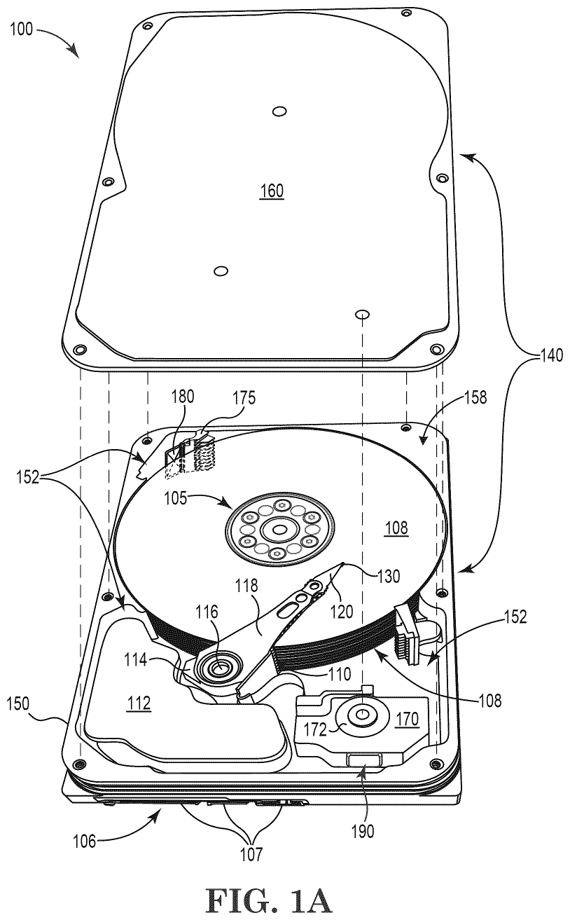

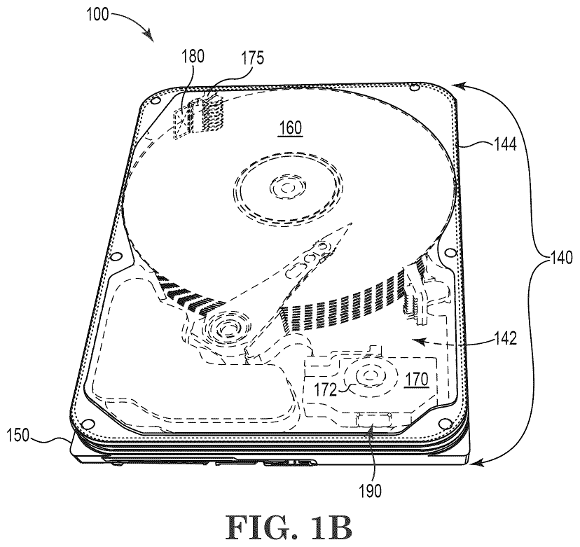

An example of a data storage device 100 that may include one or more adsorbent compositions according to the present disclosure will be described with respect to FIGS. 1A and 1B.

Data storage device 100 is illustrated as a hard-disk drive (HDD) that includes an outer enclosure or housing 140 configured to contain multiple hard-disk drive components, including electronic components. Housing 140 includes a base 150 and a top cover 160. Base 150 includes a recess or cavity 152 configured to accommodate components of data storage device 100. Data storage device 100 further includes a printed circuit board assembly (PCBA) 106. PCBA 106 of this configuration is coupled to base 150 and includes a plurality of input/output connectors 107 that are each configured to provide an interface between one or more components of data storage device 100 and one or more host devices (e.g., a computer, a server, a consumer electronic device, or the like).

Base 150 and top cover 160 may be formed from any suitable material, such as metal (e.g., aluminum), plastic, or other suitable material or combinations thereof. In some embodiments, base 150 includes multiple components, such as an outer frame and a bottom cover, that are coupled together (e.g., by screws, welding, or the like).

Top cover 160 is configured to couple to base 150 to enclose components of data storage device 100, as shown in FIG. 1B. As shown, top cover 160 is aligned with and coupled to a surface of base 150, such as a surface 158 shown in FIG. 1A, to define an interior volume 142 of data storage device 100, which includes an interior gas space. Components other than those illustrated or specifically identified in FIGS. 1A and 1B and described herein are contemplated as being positioned within the interior volume 142, such as a preamp, a load/unload ramp, and/or assembly hardware, for example. Top cover 160 can be coupled to base 150 using any suitable technique, such as using one or more screws, connection fingers, locking/clipping structures, adhesives, rivets, other mechanical fasteners, welding (e.g., ultrasonic welding) or combinations thereof.

In some embodiments, data storage device 100 can further include one or more seals disposed between base 150 and top cover 160 and configured to seal the interior volume 142 of data storage device 100. In embodiments, seal 144 can be a weld formed between base 150 and top cover 160, or seal 144 can be a form-in-place gasket (FIPG). Examples of a FIPG include epoxy (e.g., a two-part epoxy) and acrylate, among others. The FIPG may be applied along an outer edge of top cover 160 and/or base 150 and thermally cured after coupling top cover 160 to base 150, for example. Other methods of sealing can additionally or alternatively be used to connect the base 150 to top cover 160.

A gas or gas mixture may be added to interior volume 142 of data storage device 100. Helium, for example, may be included in interior volume 142 to reduce mechanical vibrations, particularly of head gimbal assemblies (HGAs) of data storage device 100. Helium may also be included within data storage device 100 to enable lower head-media spacing (HMS) between a reader and/or writer of a magnetic recording head and a magnetic disk, and thus a higher areal density capability (ADC) of data storage device 100. As mentioned above, the interior gas space of the interior volume 142 may benefit from a small amount of oxygen. In some embodiments, interior gas space can have an oxygen concentration in the range from 0.1 to less than 20 mole percent, from 0.1 to 15 mole percent, or even from 3 to 15 mole percent based on the total gas in the interior gas space, with the balance being helium.

In some embodiments, data storage device 100 can be a hermetically scaled data storage device, which can be defined by, e.g., the amount of gas (e.g., helium) that leaks from the data storage device after it has been sealed (e.g., a welded HDD). In some embodiments, a hermetically sealed data storage device having its interior gas space filled with helium gas has a nominal helium leak rate of less than 10% by volume in five years. In some embodiments, in terms of (atm cc/second), a hermetically sealed data storage device having its interior gas space filled with helium gas has a nominal helium leak rate of 10×10\hat{ }-8 atm (atmosphere) cc (cubic centimeter)/second or less at 25° C.; 8×10\hat{ }-8 atm cc/second or less, 5×10\hat{ }-8 atm cc/second or less; or even 4×10\hat{ }-8 atm cc/second or less at 25° C.

Data storage device 100 includes a head stack assembly (HSA) 110 and one or more magnetic disks configured to store bits of data. HSA 110 further includes a plurality of HGAs. Each HGA 120 includes a magnetic recording head 130 with a read head and a write head for reading data from and writing data to a surface of a magnetic disk 108. Other components of a magnetic recording head 130 can be included, such as heaters, heat sinks, and piezoelectric actuators, for example. For a heat-assisted magnetic recording (HAMR) HDD, a magnetic recording head 130 may include a light source such as a laser, a waveguide, and a near-field transducer (NFT) to heat and lower the coercivity of magnetic grains in a spot of focus on a magnetic disk 108.

Data storage device 100 further includes a motor assembly 105 configured to rotatably support magnetic disks and circumferentially rotate magnetic disks about an axis of rotation during operation. Magnetic disks are mounted on motor assembly 105 such that an annular volume of each magnetic disk 108 encircles a portion of motor assembly 105. Motor assembly 105 may rotate magnetic disks during an operation of data storage device 100 such that each magnetic disk 108 moves relative to a respective magnetic recording head 130 to enable the magnetic recording heads to read data from and/or write data to the magnetic disk 108.

Data storage device 100 also includes a voice coil drive actuator 112 that produces a magnetic field that exerts a force on an actuator mechanism 114, causing actuator mechanism 114 to rotate about a shaft 116 in either rotational direction. Rotatable drive actuator arms 118 are mechanically coupled to actuator mechanism 114 and to each HGA 120 such that as actuator mechanism 114 rotates it causes rotatable drive actuator arms 118 and HGA 120, and thus magnetic recording heads, to move relative to magnetic disks 108.

Data storage device 100 includes a diverter 175 that is proximal to magnetic disks 108. Diverter 175 is configured to divert helium and/or other interior gas mixtures(s) to reduce windage on rotatable drive actuator arms 118 which can reduce undesired vibrations that may cause a magnetic recording head 130 to move off track and/or contact a magnetic disk 108. As shown in FIG. 1A, data storage device 100 utilizes voice coil drive actuator 112 to move HGA 120 relative to magnetic disks 108; however, it is understood that other methods of causing HGA 120 to move, such as a voice coil motor (VCM), are contemplated.

As discussed above, moisture and/or organic material in an interior volume of an HDD can lead to reduced performance (e.g., reduced areal density capability) and/or reduced lifetime of an HDD. In particular, water vapor, organic aerosol particulates, and organic vapor from a variety of sources (e.g., outgassing) can compromise performance of an HDD by contaminating, degrading, and/or damaging components such as magnetic recording heads. An HDD may therefore include one or more components configured to mitigate moisture and/or organic contamination. The illustrated data storage device 100 includes components having an adsorbent composition in the form an article that permits the components to be positioned and/or mounted in the interior volume 142 of data storage device 100 so that the adsorbent composition can adsorb moisture and/or organic vapors from the interior gas. In some embodiments, a component can also include filtering capability to remove organic particulate material. As shown in FIGS. 1A and 1B, non-limiting examples of such components include an environmental control module 170, a recirculation filter 180, and a label filter 190 for such a purpose.

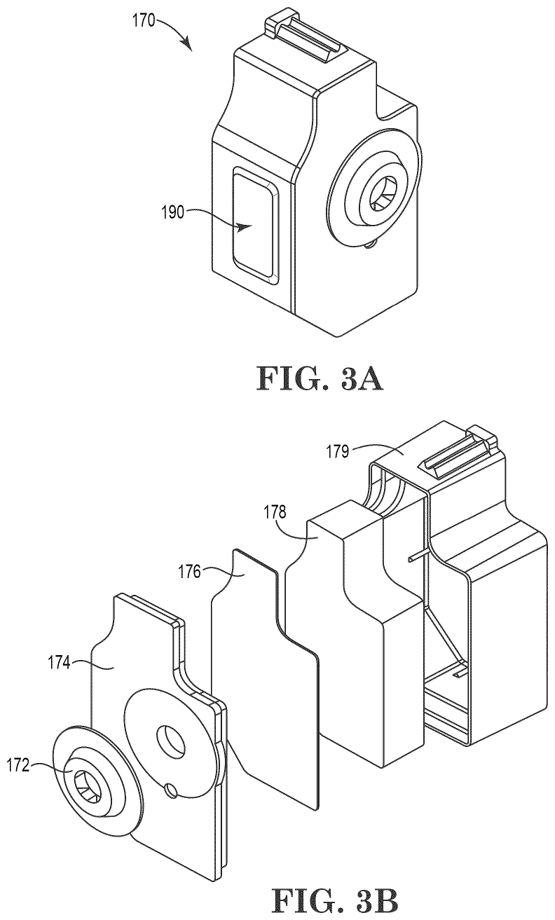

A non-limiting example of environmental control module 170 is described in more detail with respect to FIGS. 3A and 3B. As shown in FIG. 3B, environmental control module 170 includes an article 178 in the form of an environmental control module tablet that is an adsorbent composition. As shown in FIG. 3B, environmental control module tablet is configured to have a shape that conforms to the interior shape of body 179 of environmental control module 170. In some embodiments, environmental control module tablet could have a different shape that fits within body 179. As shown, environmental control module 170 also includes a lid 174 that forms a gas-tight enclosure when lid 174 is mounted to body 179. As shown, lid 174 has an inlet diffuser seal 172 that seals to top cover 160, for example. The inlet diffuser seal 172 helps keep the article 178 dry during manufacturing. The environmental control module tablet can become exposed to the interior volume 142 of data storage device 100 by breaking the inlet diffuser seal 172 to create an opening (not shown) so that gas exchange can occur between the inside of environmental control module 170 and the interior volume 142. For example, a pin can penetrate seal 172 to fill the interior volume 142 with gas (e.g., helium or helium and oxygen). As indicated by a dashed line in FIG. 1A, top cover 160 includes a through hole that lines up with the center of inlet diffuser seal 172. The through hole can be sealed after filling the interior volume 142 with gas. In some embodiments, inlet diffuser seal 172 can be made with a relatively soft material such as aluminum. Environmental control module 170 may include a filter 176 (e.g., a polytetrafluoroethylene (PTFE) membrane) that is configured to prevent particle contamination in gas that is exchange with interior volume 142, but allows gas to be exchanged between interior volume 142 and the space that includes article 148 so that the gas can contact article 148. The volume of environmental control module tablet tends to be relatively large compared to other adsorbent compositions within data storage device 100. Even though the flow of gas near environmental control module 170 tends to be relatively low, one of the functions of the environmental control module tablet shown in FIG. 3B is to adsorb moisture. In some embodiments, an environmental control module tablet can also adsorb one or more organic compounds, if desired.

Recirculation filter 180 is configured to remove contaminants from a moving and relatively high flow of gas within interior volume 142 of data storage device 100. Examples of contaminants include moisture, organic contaminants, particles, and oils, among others. The moving flow of gas may include oxygen, air, helium, and/or other gases that are disposed in interior volume 142 of data storage device 100. The gas movement can be caused by proximity to rotating magnetic disks 108 during operation of data storage device 100, for example. As shown in data storage device 100, recirculation filter 180 is coupled to and supported by diverter 175. In contrast to other components of the data storage device 100 that are configured to mitigate contamination, recirculation filter 180 can provide a higher rate of particle removal and/or organic contamination adsorption due to its proximity to moving magnetic disks 108 and the air or gas within interior volume 142 of data storage device 100.

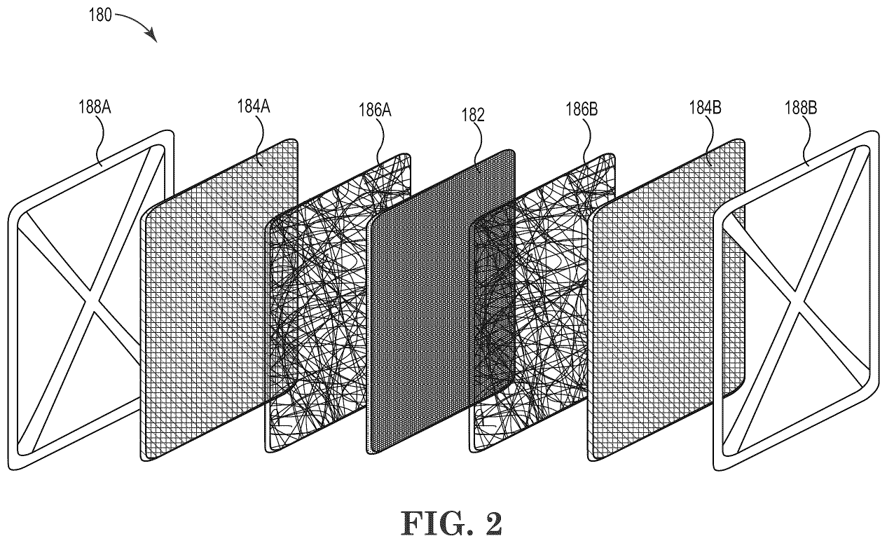

A non-limiting example of recirculation filter 180 is described in more detail with respect to FIG. 2. In accordance with aspects of this disclosure, recirculation filter 180 includes an article 182 in the form of an adsorbent layer that can be an adsorbent composition according to the present disclosure (discussed below). FIG. 2 is an exploded view of recirculation filter 180. As shown, recirculation filter 180 includes several layers, which will be described below. However, it is understood that different numbers, positioning, and/or features of the particular layers can be different than what is described relative to this non-limiting embodiment.

As mentioned above, one layer of the recirculation filter 180 includes article 182 in the form of an adsorbent layer that is an adsorbent composition according to the present disclosure. Article 182 of this embodiment is provided as a substantially rectangular sheet in the central area of the recirculation filter 180, although other positions, shapes and/or forms of an adsorbent layer are contemplated. Article 182 can include a solid structure (e.g., a honeycomb) of adsorbent composition; tablet(s); strip(s); a membrane of adsorbent composition; particles, granules, and/or beads of adsorbent composition in a sachet or on beads on web or perforated sheet; for placement in recirculation filter 180.

Recirculation filter 180 can include one or more layers to facilitate filtering and/or providing desired structural support. For example, recirculation filter 180 may include one or more scrim layers. As shown, article 182 is disposed between a first scrim layer 184A and a second scrim layer 184B. Each of first scrim layer 184A and second scrim layer 184B is configured to enclose and protect article 182. One or both of first scrim layer 184A and second scrim layer 1848 may include polypropylene, polyethylene, or polyethylene terephthalate, and/or another material. In some embodiments, one or both of first scrim layer 184A and second scrim layer 1848 include pores, a grid, an array of holes, or another open structure to enable air and gas to move through recirculation filter 180 and its respective layers.

As another example, recirculation layer may include one or more scrim layers. As shown, recirculation filter 180 further includes a first particle removal layer 186A disposed between article 182 and first scrim layer 184A and a second particle removal layer 186B disposed between article 182 and second scrim layer 184B. Each of first particle removal layer 186A and second particle removal layer 186B may include nonwoven fibers including polypropylene, polyethylene, other polymeric or non-polymeric materials, and/or the like. Recirculation filter can also include outer layers 188A and 188B adjacent to first scrim layer 184A and second scrim layer 184B, respectively, that provide structural support for the recirculation filter 180. Other layers having the same or different functions as those described are also contemplated.

As shown in FIGS. 1A, 1B, and 3A, label filter 190 is located on a side of environmental control module 170. In some embodiments, label filter 190 can be mounted to environmental control module 170 using an adhesive. In some embodiments, label filter 190 can be securely positioned in a slot located, with or without an adhesive, in any desired location (e.g., on a side of environmental control module 170). Because label filter 190 is located near environmental control module 170, the flow of gas near label filter 190 likewise tends to be relatively low. Similar to recirculation filter 180, one of the functions of label filter 190 is to adsorb one or more organic compounds.

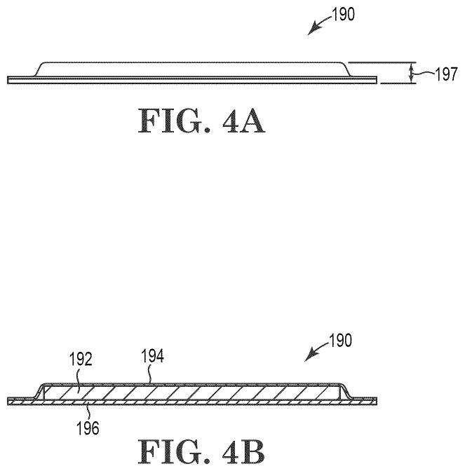

A non-limiting example of label filter 190 is described in more detail with respect to FIGS. 4A and 4B. As shown in FIG. 4A, label filter 190 has a thickness 197, which tends to be relatively small such that label filter 190 has a low profile. As shown in FIG. 4B, label filter 190 includes an article 192 in the form of an adsorbent layer that can be an adsorbent composition according to the present disclosure (discussed below). Article 192 is enclosed in a manner that permits gas exchange between article 192 and the interior volume 142. For example, cover 194 can be a membrane that is permeable to permit organic compounds to flow through cover 194 and be adsorbed by article 192. A non-limiting example of cover 194 includes a polytetrafluoroethylene (PTFE) membrane that is configured to prevent particles from article 192 from entering interior volume 142. The base 196 can be a film is the same material or different material from cover 194. In some embodiments, base 196 is an adhesive that permits label filter 190 to be mounted to environmental control module 170.

As mentioned, articles including an adsorbent composition can be adapted to be disposed in a housing of a data storage device. The adsorbent composition includes an adsorbent component and a binder component, which are discussed in detail below.

The adsorbent component can adsorb one or more molecules from an interior gas space in the housing. The adsorbent component can adsorb one or more molecules via physisorption via Van der Waals force and/or chemisorption. The one or more molecules include at least organic compounds. A magnetic recording media used in a (HAMR) HDD was evaluated and it was determined that a number of organic compounds (contaminants) adsorbed and detected on media surface that may get into the head-disk interface and cause HDD reliability issues include at least polar organic compounds. There can also be organic compounds that are non-polar. Non-limiting examples of organic compounds (contaminants) adsorbed and detected on media surface include organic alcohols, ether, plasticizers, and the like, such as 2-(2phenoxyl ethoxy)ethanol; 2-(nonylphenoxy)ethanol; ethanol, 2-[4-(1,1-dimethyl)phenoxyl]; 2-propanol, 1,3-diphenoxy; 2-propanol, 1-(2-butoxy-1-methyloxy); tri(propylene glycol) propyl ether; dibutyl phthalate; and bis(2-ethylhexyl)phthalate. According to the present disclosure, one or more molecular sieves can be selected to replace at least a portion of, or substantially all, activated carbon in an adsorbent component for adsorbing one or more organic compounds. To help select molecular sieves that have a nominal pore size that is large enough for identified organic compounds to physically fit in the pores, the kinematic diameter of each compound can be considered. The kinematic diameter is a measure applied to atoms and molecules that indicates the likelihood that the atom or molecule in a gas will collide with another molecule. In other words, it is an indication of the size of an atom or molecule as a target. Kinematic diameter is not the same as atomic diameter defined in terms of the electron shell, which tends to be smaller. Because the kinematic diameter of at least some of the identified organic compounds was not readily available, the kinematic diameters of toluene and xylene were used to estimate a range of kinetic diameters for the identified organic compounds. It is estimated that a relatively high number of the organic compounds (contaminants) adsorbed and detected on media surface that may get into the head-disk interface and cause HDD reliability issues are polar organic compounds having kinetic diameters in the range of 6 to 10 angstroms. There can also be organic compounds that are polar or non-polar and/or that have a kinematic diameter greater than 10 angstroms.

One or more molecular sieves can be selected to adsorb one or more organic compounds based on factors such as nominal pores size of the molecular sieve, one or more surface properties, combinations of these, and the like.

With respect to nominal pore size, in some embodiments, one or more molecular sieves that can adsorb one or more organic molecules have nominal pore size in a range from greater than 4 angstroms to 10 angstroms, or even from 5 angstroms to 10 angstroms. Optionally or alternatively, one or more molecular sieves that can adsorb one or more organic molecules have a nominal pore size of greater than 10 angstroms. For example, one or more molecular sieves that can adsorb one or more organic molecules have a nominal pore size in a range from 20 angstroms to 80 angstroms, or even from 30 angstroms to 70 angstroms. The pore size of molecular sieves can be classified using the International Union of Pure and Applied Chemistry (IUPAC) classification of pore size as follows: 1) micropore is less than 2 nm (20 Å); 2) mesopore is greater than or equal to 2 nm (20 Å) but less than or equal to 50 nm (500 Å); and 3) Macropore is greater than 50 nm (500 Å).

With respect to surface properties of molecular sieves, in some embodiments, a molecular sieve can be selected based on its mole ratio of SiO₂ to Al₂O₃. As the mole ratio of SiO₂ to Al₂O₃ decreases for a molecular sieve, the molecular sieve tends to be more hydrophilic. In contrast, as the mole ratio of SiO₂ to Al₂O₃ increases for a molecular sieve, the molecular sieve tends to be more hydrophobic. For example, for two molecular sieves that are otherwise the same type, the molecular sieve with a lower mole ratio of SiO₂ to Al₂O₃ tends to preferentially adsorb more polar organic compounds. In some embodiments, if desired, the mole ratio of SiO₂ to Al₂O₃ can be adjusted by modifying the silica content of the molecular sieves. In some embodiments, at least a portion of molecular sieves have a mole ratio of SiO₂ to Al₂O₃ that is less than the mole ratio of SiO₂ to Al₂O₃ of another portion of molecular sieves, where each portion of the molecular sieves can adsorb one or more organic molecules. In some embodiments, one or more molecular sieves can have a mole ratio of SiO₂ (silica) to Al₂O₃ (alumina) equal to 50 or less, 30 or less, or even 10 or less. In some embodiments, one or more molecular sieves can have a mole ratio of SiO₂ to Al₂O₃ in the range from 1 to 50, from 1 to 30, or even from 1 to 10.

Non-limiting examples of types of molecular sieves that can adsorb one or more organic molecules include Type A molecular sieves, Type X molecular sieves, Type Y molecular sieves, Type Beta molecular sieves, MCM molecular sieves, ZSM molecular sieves, SAPO molecular sieves, and combinations thereof. Type X molecular sieves have a relatively larger nominal pore size than Type Y molecular sieves so Type X molecular sieves can adsorb some larger organic compounds. MCM molecular sieves such as MCM-41 molecular sieves have nominal pore sizes in the mesoporous range, typically 30 to 70 angstroms, which can adsorb some organic compounds whose kinetic diameters are larger than 10 angstroms. Type Beta molecular sieves have relatively more surface hydroxyl groups than one or more other molecular sieves, making it more hydrophilic, and relatively more suitable for adsorbing polar organic compounds.

In some embodiments, one or more molecular sieves can be selected for adsorbing one or more organic molecules based on their ability to adsorb 2,2,4-trimethyl pentane (TMP) and/or ethanol. TMP and ethanol have essentially the same kinetic diameter (4.5 angstroms) and very similar vapor pressures. However, TMP is different from ethanol in that TMP is a non-polar organic compound while ethanol is a polar organic compound. Thus, the adsorption capacity of TMP and ethanol of a molecular sieve is used to compare how much the molecular sieve can adsorb non-polar organics and polar organic compounds. Table 1 below shows adsorption capacity of TMP and ethanol of various adsorbents.

TABLE 1

| | Adsorption capacity | Adsorption capacity |
|---|---|---|
| | of TMP (weight | of ethanol (weight |
| Adsorbent | percent) | percent) |
| Activated Carbon | 12.62% | 1.27% |
| Type X (13X) molecular | 3.13% | Not tested |
| sieve | | |
| Type Y (mole ratio of SiO₂ | 6.20% | Not tested |
| to Al₂O₃ is 18) molecular | | |
| sieve | | |
| Type Y (mole ratio of SiO₂ | 6.07% | 2.7% |
| to Al₂O₃ is 60) molecular | | |
| sieve | | |
| Type Beta (mole ratio of | 9.72% | 7.8% |
| SiO₂ to Al₂O₃ is 120) | | |
| molecular sieve | | |
| MCM-41 molecular sieve | 1.38% | Not tested |

As can be seen, Type Beta molecular sieve can adsorb relatively much more polar ethanol than activated carbon and the other tested molecular sieves due to its very hydrophilic sites on its surface, which is helpful in the context of a sealed HDD that includes a relatively high proportion of polar organic compounds. As can also be seen, Type Beta molecular sieve can also adsorb TMP because it also has hydrophobic sites.

It is noted that the one or more molecular sieves that can adsorb one or more organic molecules may also be able to adsorb moisture. In some embodiments, to help provide such molecular sieves with capacity to absorb the one or more organic molecules, one or more factors can be considered when formulating an adsorbent composition according to the present disclosure.

One factor to consider is nominal pores size of a molecular sieve since many organic compounds that may be present in the interior gas space of a HDD have a kinetic diameter (e.g., more than 4 or 5 angstroms) that is larger than the kinetic diameter of water (2.65 angstroms). Different molecular sieves having different nominal pore sizes can be included in an adsorbent composition to help manage adsorption of moisture that may otherwise occur by molecular sieves having a nominal pore size greater than 4 angstroms and intended to adsorb one or more organic compounds. For example, an amount of molecular sieves that are limited in nominal pore size can optionally be included in an adsorbent composition according to the present disclosure to provide at least some capacity intended for moisture adsorption. An example of molecular sieves that are limited in in nominal pore size include molecular sieves having a nominal pore size of 4 angstroms or less, or even 3 angstroms or less. Non-limiting examples of such molecular sieves that are limited in nominal pore size include Type 3A molecular sieves and/or Type 4A molecular sieves. This helps the molecular sieves having a nominal pore size greater than 4 angstroms maintain sufficient capacity to adsorb one or more organic compounds.

Another factor to consider for preferential adsorption of one or more organic compounds relative to moisture includes one or more surface properties of a molecular sieve. For example, a molecular sieve can be selected based on its mole ratio of SiO₂ to Al₂O₃. As discussed above, the mole ratio of SiO₂ to Al₂O₃ of a molecular sieve impacts the hydrophilicity of the molecular sieve.

A molecular sieve component can be present in an adsorbent composition in a range of amounts that depend on, e.g., the composition of the adsorbent component, the shape and size of the article formed, and the like. While an adsorbent composition could include minor amounts of one or more adsorbents other than one or more molecular sieves that adsorb one or more organic compounds, the adsorbent composition according to the present disclosure does not adsorb an undue amount of any oxygen that may be present in the interior gas space of a HAMR HDD.

For illustration purposes, an example of formulating an amount of a molecular sieve component in an adsorbent composition for a recirculation filter and/or label filter will be described. In some embodiments, a molecular sieve component can be present in an adsorbent composition in an amount of 5% or greater, 50% or greater, 65% or greater, 75% or greater, 85% or greater, or even 95% or greater by total weight of the adsorbent composition. In some embodiments, a molecular sieve component can be present in an adsorbent composition in an amount from 5% to 95%, 10% to 90%, from 30% to 80%, from 40% to 70%, from 40% to 60% or even from 50% to 95% by total weight of the adsorbent composition. As mentioned above, an amount of molecular sieves that are limited in nominal pore size (e.g., nominal pore size of 4 angstroms or less) can optionally be included in one or more articles according to the present disclosure to provide at least some capacity intended for moisture adsorption. In some embodiments, the molecular sieve component includes 80% or more, 85% or more, 90% or more, 95% or more, or even 99% or more of one or more molecular sieves that adsorb one or more organic compounds, based on the total weight of the molecular sieve component.

As mentioned above, an adsorbent composition according to the present disclosure also includes a binder component. A binder component includes one or more binders. A binder is mixed with the adsorbent component to bind the particles or granules of the adsorbent component to form the mixture into an article having a desired shape so that the article can be positioned within a data storage device as described herein. A binder can also be selected to mitigate any loosening or dislodging of adsorbent component particles during manufacture, handling, storage, transportation, and/or operation of a data storage device.

According to the present disclosure, a binder component includes at least one rubber. A “rubber” refers to an elastomer that is cured or uncured. A “cured rubber” refers to a rubber that has been exposed to curing conditions to at least partially (e.g., substantially fully) cure the uncured rubber. A “uncured rubber” refers to a rubber that has not been exposed to curing conditions yet. A rubber can be selected as a binder based on its ability able to mix with the adsorbent component and shape the mixture into an article as discussed above that can hold its shape and not release an undue amount of adsorbent component particles from the article (discussed below).

A rubber can also be selected so that it has little to no outgassing of organic compounds in its cured state, thereby reducing the amount of organic contamination that can occur with some organic binders such as, e.g., polyvinylpyrrolidone (PVP). Further, a rubber can be selected based on its ability to withstand relatively high-temperature conditions (e.g., curing and/or baking), discussed below, which can advantageously help reduce the presence of one or more organic contaminants in the article while still maintaining the integrity and shape of the article. A rubber can also be selected so that the cured rubber is sufficiently elastic and flexible for manufacture of a corresponding article (e.g., recirculation filter), which can include one or more of perforating, cutting, and the like.

An example of a rubber that can be used in a binder component according to the present disclosure includes one or more fluorocarbon-based fluoroelastomers. Fluorocarbon-based elastomers are synthetic rubbers that can be formed by emulsion polymerization or suspension polymerization. Non-limiting examples of fluorocarbon-based elastomers are Fluorine Kautschuk Material (FKM), which is defined by ASTM D1418-22 and ISO 1629. FKM includes vinylidene fluoride as the common monomer, to which one or more different monomers can be added for specific types and functionality, as desired. Non-limiting examples of FKMs include Type-1 FKMs, Type-2 FKMs, Type-3 FKMs, Type-4 FKMs, and Type-5 FKMs. Type-1 FKMs contain vinylidene fluoride (VDF) and hexafluoropropylene (HFP). Type-2 FKMs contain VDF, HFP, and tetrafluoroethylene (TFE). Terpolymers have a higher fluorine content compared to copolymers, which can result in better chemical and heat resistance. Type-3 FKMs contain VDF, TFE, and perfluoromethylvinylether (PMVE). Including PMVE can provide better low temperature flexibility compared to copolymers and terpolymers. Type-4 FKMs contain propylene, TFE, and VDF. Type-5 FKMs contain VDF, HFP, TFE, PMVE, and ethylene.

Additional examples of rubbers that can be used in a binder component according to the present disclosure include silicone rubber (VMQ), perfluoroelastomer (FFKM), butyl rubber (BR), fluorosilicone rubber (FVMQ), and combinations thereof.

For illustration purposes, an example of formulating an amount of a binder component in an adsorbent composition for a recirculation filter and/or label filter will be described. A binder component can be present in an adsorbent composition in a range of amounts that depend on, e.g., the composition of the molecular sieve component, the shape and size of the article formed, and the like. In some embodiments, a binder component can be present in an adsorbent composition in an amount of 95% or less, 90% or less, 70% or less, 60% or less, 50% or less, or even 40% or less by total weight of the adsorbent composition. In some embodiments, a binder component can be present in an adsorbent composition in an amount from 5% to 95%, 10% to 90%, from 30% to 80%, from 40% to 70%, from 40% to 60% or even from 5% to 50% by total weight of the adsorbent composition. While a binder component could include minor amounts of one or more binders other than rubber according to the present disclosure, the binder component is selected to not contribute an undue amount of outgassing of organic compounds into the interior gas space of a data storage device. In some embodiments, the binder component includes 80% or more, 85% or more, 90% or more, 95% or more, or even 99% or more of one or more rubbers based on the total weight of the binder component.

An article that includes an adsorbent composition according to the present disclosure can be made by forming a mixture of an adsorbent component, a binder component, and forming the mixture into the shape of an article.

In some embodiments, one or more uncured rubbers and/or one or more cured rubbers can be mixed with an adsorbent composition and formed into the shape of an article. For example, one or more uncured rubbers can be selected to mix with the adsorbent component and shaped into an article so that the article holds its shape after curing. As another example, one or more cured rubbers can be selected based on desirable adhesion properties of the cured rubbers and mixed with the adsorbent component to shape the mixture into an article and so that the article holds its shape without subsequent curing (although subsequent baking could still occur).

In some embodiments, molecular sieves can be calcined prior to mixing molecular sieves with binder component. For example, molecular sieves can be calcined at temperatures up to 700° C. or more (e.g., from 300° C. to 900° C.) to remove trace organic contaminants.

The adsorbent component and binder component can be combined and mixed (compounded) in any desired manner that forms a mixture that is relatively homogeneous and facilitates forming an article having a desired shape, e.g., as described above. Optionally, one or more additional ingredients can be combined with the adsorbent component and binder component, and mixed. Non-limiting examples of such additional ingredients include one or more solvents, one or more curing agents (e.g., bisphenol or peroxide), one or more fillers, one or more stabilizers, one or more processing aids, combinations of these, and the like.

The mixture can be formed into a shape using, e.g., a mold in the shape of the desired article to be disposed in a data storage device. Non-limiting examples of techniques that can be used for shaping include compression molding, injection molding, extrusion, and the like.

As mentioned, the binder component can include one or more uncured rubbers, which can be cured to form the final article.

Curing a rubber refers to a process of crosslinking polymer chains to enhance properties, e.g., mechanical properties, of the rubber. The curing process forms strong chemical bonds between the chains, which strengthens and stabilizes the rubber. A variety of curing methods can be used to cure a rubber. The choice of curing method depends on the specific rubber, and desired properties. Non-limiting examples of curing a rubber include sulfur curing (vulcanization), bisphenol curing, peroxide curing, amination curing, radiation curing, ultraviolet (UV) curing, and combinations thereof. Bisphenol curing can include using bisphenol compounds (e.g., bisphenol AF) and a quaternary phosphonium salt as a co-curing agent. The curing agent can interact with the polymer (e.g., fluoropolymer chain), thereby creating crosslinks. Peroxide curing involves using organic peroxides as crosslinking agents. The peroxides generate free radicals upon heating, which then form crosslinks. Amination uses diamines as crosslinkers.

In some embodiments, one or more solvents can be combined with uncured rubber to facilitate mixing the adsorbent component and the binder component. If desired, molecular sieves can be “pre-mixed” with the one or more solvents to occupy pores in the molecular sieves prior to mixing the molecular sieves with the uncured rubber. Pre-mixing the molecular sieves with solvent can avoid or reduce clogging of the pores by the rubber. Next, the molecular sieve/solvent mixture can be mixed with the binder component and shaped into the article, followed by curing. During subsequent curing and/or baking of the mixture, solvent that is present in the pores can volatilize and escape from the pores, thereby leaving the pores empty and avoiding undue reduction in adsorbing capacity of the article.

In some embodiments, curing can include exposing the mixture to a temperature of at least 150° C., at least 200° C., at least 250° C., or even at least 300° C. In some embodiments, curing can include exposing the mixture to a temperature from 150° C. to 350° C., or from 200° C. to 300° C. In some embodiments, curing can include exposing the mixture to a temperature just described for a time period of at least 90 minutes, at least 120 minutes, or even at least 180 minutes. In some embodiments, curing can include exposing the mixture to a temperature just described for a time period from 30 minutes to 5 hours, or even from 1 to 3 hours.

In addition to curing uncured rubber, exposing the mixture to an elevated temperature can remove organic contaminants while still maintaining the integrity and shape of the article. For example, prior to curing, an uncured rubber may include organic contaminants such as monomers and/or oligomers.

Optionally, if desired, an article can be exposed to baking conditions. For example, if an adsorbent composition is exposed to elevated temperature for curing, a separate, post-curing, baking protocol can be performed. In some embodiments, baking conditions include exposing the mixture to a temperature of at least 150° C., at least 200° C., at least 250° C., or even at least 300° C. In some embodiments, baking conditions include exposing the article to a temperature from 150° C. to 350° C., or from 200° C. to 300° C. In some embodiments, baking conditions include exposing the article to a temperature just described for a time period of at least 90 minutes, at least 120 minutes, or even at least 180 minutes. In some embodiments, baking conditions include exposing the article to a temperature just described for a time period from 30 minutes to 5 hours, or even from 1 to 3 hours.

Baking can help stabilize and enhance the final properties of the cured rubber. For example, baking can also remove organic contaminants while still maintaining the integrity and shape of the article.

Heating for curing and/or baking can be performed using an oven, such as a convection oven.

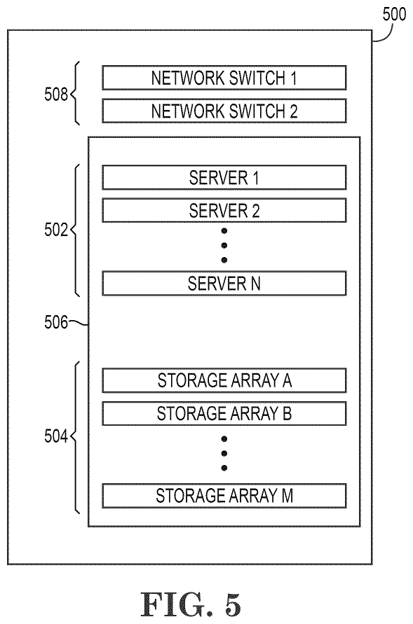

FIG. 5 illustrates a non-limiting example of a computing system 500 that includes a plurality of data storge devices (e.g., data storage device 100) that include an absorbent composition according to the present disclosure. In FIG. 5, a diagram shows a computing system 500 that can have a computing enclosure used in network storage services. As shown, the computing enclosure includes a plurality of servers 502 coupled to a plurality of drive arrays 504 via a rack-level network fabric 506. Each server 502 can include at least one CPU coupled to random access memory (RAM) and an input/output (IO) subsystem. Each server 502 may have one or more dedicated power supplies (not shown) or the enclosure may provide power through a power bus (not shown). Each server 502 may also have an IO interface for connecting to the rack-level network fabric 506.

The drive arrays 504 may each include a separate sub-enclosure with IO busses, power supplies, storage controllers, etc. The drive arrays 504 include a plurality of individual data storage devices (e.g., HDD) densely packed into the sub-enclosure. An example of a data center that includes a computing system have a plurality of data storage devices is also described in U.S. Pat. No. 11,567,834 (Bent et al.).

What is claimed is:

1. An article adapted to be disposed in a housing of a sealed, data storage device, wherein the article comprises an adsorbent composition comprising:
a molecular sieve component comprising one or more molecular sieves that can adsorb one or more organic compounds; and
a binder component comprising at least one cured rubber.

2. The article of claim 1, wherein the one or more molecular sieves have a nominal pore size of greater than 4 angstroms.

3. The article of claim 1, wherein the one or more molecular sieves chosen from Type A molecular sieves, Type X molecular sieves, Type Y molecular sieves, Type Beta molecular sieves, MCM molecular sieves, ZSM molecular sieves, SAPO molecular sieves, and combinations thereof.

4. The article of claim 1, wherein the molecular sieve component comprises a first plurality of molecular sieves each having a nominal pore size in a range from greater than 4 angstroms to 10 angstroms and a second plurality of molecular sieves each having a nominal pore size of greater than 10 angstroms.

5. The article of claim 4, wherein at least a first portion of the first plurality of molecular sieves has a first mole ratio of SiO₂ to Al₂O₃, wherein at least a second portion of the first plurality of molecular sieves has a second mole ratio of SiO₂ to Al₂O₃, and wherein the first mole ratio is less than the second mole ratio.

6. The article of claim 1, wherein the at least one cured rubber comprises at least one fluorocarbon-based elastomer comprising vinylidene fluoride.

7. The article of claim 1, wherein the molecular sieve component is present in an amount of 5% or greater by total weight of the adsorbent composition, and wherein the binder component is present in an amount of 95% or less by total weight of the adsorbent composition.

8. The article of claim 1, wherein the article comprises a filter, and wherein the molecular sieve component is present in an amount from 50% to 95% by total weight of the adsorbent composition, and wherein the binder component is present in an amount from 5% to 50% by total weight of the adsorbent composition.

9. The article of claim 8, wherein the filter is configured to remove contaminants from a moving flow of gas within an interior gas space of the housing of the sealed, data storage device.

10. The article of claim 9, wherein the adsorbent composition is disposed between a first scrim layer and a second scrim layer, and wherein each of the first scrim layer and the second scrim layer are configured to enclose and protect the adsorbent composition.

11. The article of claim 10, wherein the filter further comprises at least one particle removal layer disposed between the adsorbent composition and at least one of the first scrim layer and the second scrim layer.

12. The article of claim 8, wherein the filter comprises a recirculation filter.

13. The article of claim 8, wherein the filter comprises a label filter.

14. A sealed, data storage device comprising:
the housing having an interior gas space;
one or more electronic components disposed within the housing; and
at least one article according to claim 1.

15. The sealed, data storage device of claim 14, wherein the interior gas space of the sealed, data storage device comprises helium gas and the sealed, data storage device has a helium leak rate of 10×10\hat{ }-8 atm (atmosphere) cc (cubic centimeter)/second or less at 25° C.

16. The sealed, data storage device of claim 14, wherein the sealed, data storage device is a heat-assisted magnetic recording hard disk drive.

17. A computing system comprising a plurality of sealed, data storge devices according to claim 14.

18. A method of making an article adapted to be disposed in a housing of a sealed, data storage device, wherein the method comprises:
forming a mixture comprising:
a molecular sieve component comprising one or more molecular sieves that can adsorb one or more organic compounds; and
a binder component comprising at least one rubber; and
forming the mixture into the article.

19. The method of claim 18, wherein the at least one rubber comprises at least one uncured rubber, and further comprising curing the at least one rubber that is present in the mixture to form the article.

20. The method of claim 19, wherein the curing comprises vulcanization, bisphenol curing, peroxide curing, amination curing, and combinations thereof.
